(19) United States
(12) Patent Application Publication
(10) Pub. No.: US 2018/0029183 A1
(43) Pub. Date: Feb. 1, 2018

(54) Apparatus and Method for Programmable Coolant Delivery in CNC Machines

(71) Applicants: Robert Yellin, Austin, TX (US); Daniel Rogge, Madison, WI (US)

(72) Inventors: Robert Yellin, Austin, TX (US); Daniel Rogge, Madison, WI (US)

(73) Assignee: Tormach, Inc., Waunakee, WI (US)

(21) Appl. No.: 15/661,782

(22) Filed: Jul. 27, 2017

Related U.S. Application Data
(60) Provisional application No. 62/368,860, filed on Jul. 29, 2016.

(51) Int. Cl. B23Q 11/10; G05B 19/29

(52) U.S. Cl. CPC B23Q 11/1076; G05B 19/29; G05B 2219/50248

(57) ABSTRACT

A method and apparatus for directing a coolant stream for use with a computer numerically controlled (CNC) machine tool includes a nozzle pivotably mounted on a machine tool. The position of the nozzle is automatically adjusted using information available in the CNC machine control program and the part program (i.e. G-Code) to determine where to direct the coolant nozzle at each instant in time. Integration with the machine control program allows the coolant delivery system to be continuously adaptive to machine position. The position of the coolant delivery system is computed by algorithms according to a user selected strategy. The strategy is specified within the control language of the machine control program (i.e. G-Code). No operator programming outside of using G-Code commands to select the desired operating mode is required to direct the coolant nozzle. The user can change operating modes while the machine is running by issuing G-Code commands.

### BACKGROUND OF THE INVENTION

### Field of the Invention

The present invention relates generally to the need in many types of computer numerically controlled (CNC) machines to deliver coolant for cooling and lubrication during a machining process. The invention enables a new method and apparatus for controlling and directing coolant that eliminates the need for operator programming for each tool selection and cutting strategy. Due to its simplicity, timesaving, and low cost the invention relates to many types of CNC machines and devices including milling machines, lathes, and grinders.

### Description of the Prior Art

There is a well-known need in the CNC machine tool art for accurately guided coolant delivery. CNC machinery therefore typically employs some method of delivering coolant to the cutting tool to remove heat and provide lubrication. In its simplest form the coolant is delivered via a hose to a nozzle mounted to either a fixed location, such as a frame component, or a moving component, such as through a tool, through the tool changer holding the tool, the vertical head of a mill, or the cross slide of a lathe.

In operation these simple coolant delivery systems require frequent manual adjustment of the nozzle to direct the coolant to the optimal location. It can be difficult for an operator to properly direct the coolant manually. In addition, when the machine changes cutting tools the optimal position for the coolant stream changes. Operator intervention each time a tool is changed defeats some of the efficiency offered by CNC machines. Operator intervention to manually adjust the nozzle can also involve interrupting the machining operation, slowing down the process, or subjecting the operator to hazardous conditions.

To mitigate these issues there are existing devices described in the prior art which provide for “programmable” coolant delivery. These devices typically employ a mechanism which automatically directs the coolant to a programmed location, depending upon the cutting tool being used. Programming often entails manually updating a specification table in the control program, or manually programming the automated mechanism by means of controls, dials or buttons to a predetermined location for each unique tool. This definition or configuration of the coolant delivery position is typically static, in that it defines a fixed position and/or angular orientation of the coolant nozzle for each cutting tool.

In addition, many existing coolant delivery systems employ one type of coolant in the automated nozzle or dispenser. As such, only one coolant medium, for example mist, flood, air, liquid nitrogen, etc, may be delivered by the coolant delivery device.

Turning now to the prior art U.S. Pat. No. 6,772,042 (Warren) discloses a programmable coolant delivery system using a rotatable coolant block. Warren requires the operator to program nozzle position instructions for each tool. Warren requires gathering of information via electrical signals from an automatic tool changer system and then uses this information to keep track of which tool is currently active. Based on the active tool Warren then calls up the appropriate nozzle direction program from its computer memory. Warren also requires setting up and using communication between the coolant control system and the automatic tool changer system. None of the parameters for directing a coolant stream can be changed while a machining program is executing.

US Pat. App. 2016/0184951 A1 (Kurokawa) discloses a cutting fluid supply system for a machine tool with a nozzle moving unit driven by instructions from an information processing unit. Kurokawa requires an object identification unit which is capable of recognizing the position and shape of an object (a work piece). This object identification unit adds considerable cost and complexity to the system as it requires extra sensors and data processing. The sensors of Kurokawa must function inside of the machine tool operating environment which typically includes splashing coolant and unknown amounts of chips and debris from the cutting operations. The object identification unit must be able to distinguish the work piece from these unknown chips and debris.

U.S. Pat. No. 5,444,634 (Goldman) discloses a lubricant nozzle positioning system for use with a machine tool automatic tool changer. Goldman requires an operator to adjust the position of the coolant nozzle manually for each tool by electronically jogging the coolant positioning motor via keypad to the desired location. When the coolant stream is directed at the desired location the user records this location in a register in the machine tool's tool offset table. One set of positioning coordinates is used for each cutting tool. Goldman requires time consuming setup to direct and record nozzle positions for each cutting tool used and can only direct a coolant stream at one location for each cutting tool. None of the parameters for directing a coolant stream can be changed while a machining program is executing.

US Pat. App. 2010/0130106 A1 (Hyatt) discloses a computer numerically controlled machine having a coolant nozzle mounted on the machine that is rotatable. The nozzle has considerable flexibility in terms of various operating modes, but it requires the operator to write or supply unique computer code for every nozzle position and movement desired. On a milling machine or lathe using various cutting tools a different computer code is required for each cutting tool. In addition Hyatt does not disclose any specific coolant strategies for directing a coolant stream. None of the parameters for directing a coolant stream can be changed while a machining program is executing.

U.S. Pat. No. 9,393,671 (Webster) teaches the use of a programmable coolant delivery system for grinding machines. Webster is primarily concerned with adjusting the coolant nozzle as the grinding wheel diameter changes. Webster requires a parallelogram mechanism as well as a drive system for moving a coolant nozzle. Webster requires an individual program to be written for each application. Webster is not readily transferable to machines, such as milling machines, that frequently change tools and where the intersection of the tool and work piece can vary depending on the machining process. In Webster none of the parameters for directing a coolant stream can be changed while a machining program is executing.

U.S. Pat. No. 6,715,971 (Curtis) discloses a method and apparatus for directing a coolant stream onto a cutting tool that includes a nozzle pivotably mounted on a machine tool. Curtis uses an all mechanical system to automatically adjust the nozzle position in response to movement of the machine tool and changes in cutting tools. Curtis's method and apparatus are not capable of using more than one nozzle position pattern for a given cutting tool. The user cannot change the coolant direction strategy since it is built into the mechanical system. Curtis includes complex and costly mechanical components used to align and position the coolant nozzle and is not capable of adapting in more than one way to different work piece and cutting tool interface geometries.

### SUMMARY OF THE INVENTION

In view of the foregoing disadvantages inherent in the design, programming and use of prior art methods for controlling the direction of a coolant nozzle for a CNC machine the present invention provides an improved apparatus and method to control the direction of a coolant nozzle in a simple and effective manner without requiring complex operator set up or programming for each tool.

The present invention uses information available in the CNC machine control program that controls machine tool operation and the part program (i.e. G-Code) that defines the manufacturing processes to determine where to direct the coolant nozzle at each instant in time.

Integration with the machine control program allows the coolant delivery system of the present invention to be continuously adaptive to machine position. This is a key distinction between the present invention and the prior art. In addition, it would be extremely tedious, impractical, and nearly impossible for a human to follow the machine movements with manual adjustments of a coolant nozzle. The use of the present invention therefore enables a level of precision and timeliness when providing coolant that is not attainable by other means.

In the present invention the position of the coolant delivery system nozzle is not statically programmed by the user to direct a coolant stream to a fixed location, but rather it is computed by algorithms according to a user selected strategy. The strategy used to determine coolant stream target location is specified by the user within the part program (i.e. G-Code) that defines the machining process.

The coolant stream target location is then algorithmically derived from the user strategy selected in the part program. The tool type/length and the position of the tool and machine relative to the cutting surface are accessed from the machine control computer. This process is dynamic, and is continuously adjusted if any of the determining values changes. The user does not input any extra information about any cutting tool for the coolant delivery system. The coolant delivery system automatically accesses all necessary information about cutting tools from the data provided by the user in the machine control computer tool table. This eliminates time consuming extra work on the part of the user.

Using the present invention it is no longer necessary for the operator to enter nozzle positioning values into a data table, jog a nozzle to a specific position, or write computer code to specify the coolant nozzle position for any cutting tool. With the present invention the only operator programming required is to specify the desired coolant operating mode parameters in the part program (G-Code). The control of the coolant nozzle position is dynamic and constantly updated according to the user specified strategy as machining processes are carried out.

The present invention offers several modes of operation a user can select with simple G-Code commands. The user can change operating modes at any time by issuing G-Code commands. This can be done while the G-Code program is running. The ability to change the coolant operating mode while a part program is running, for example to accommodate unexpected machining conditions, is not available in the prior art.

The coolant nozzle position is not required to be static when using the present invention. In addition to automatic coolant nozzle adjustment in response to changes in machine configuration the operator can choose modes that periodically vary the coolant nozzle position in real time as desired in response to the mode selected, the tool position, and the position of the work piece.

Finally, the user can override the automatic nozzle control at any time and manually direct the coolant stream position by using key presses on the machine control computer keypad.

There have thus been broadly outlined the more important features of the invention in order that the detailed description thereof that follows may be better understood, and in order that the present contribution to the art may be better appreciated. There are, of course, additional features of the invention that will be described hereinafter.

In this respect, before explaining the invention in detail, it is to be understood that the invention is not limited in its application to the details of construction and to the arrangements of the components set forth in the following description and illustrated in the drawings. The invention is capable of other embodiments and of being practiced and carried out in various ways.

Also, it is to be understood that the phraseology and terminology employed herein are for the purpose of description and should not be regarded as limiting. As such, those skilled in the art will appreciate that the conception, upon which this disclosure is based, may readily be utilized as a basis for the design of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved apparatus and method for implementing programmable coolant nozzle control in CNC machines which has all of the advantages of prior art machines and none of the disadvantages. An important advantage of the present invention is that by interfacing with the machine control software in real time it enables the coolant delivery system to be continuously adaptive to machine position and tool position.

Another object of the present invention is to eliminate the need to train or program the coolant delivery system for each cutting tool or cooling strategy. The user simply selects options with G-Code commands to implement the desired coolant positioning strategy. The software of the present invention then uses algorithms to calculate the proper coolant nozzle positon, which can vary dynamically in real time during a machining operation in response to machine tool position, work piece position and the selected strategy.

It is yet another object of the present invention to allow an operator to make real time changes to coolant operating strategy during the execution of a G-Code program, or even manually direct coolant using a keypress, to accommodate unexpected changes in coolant needs and machining conditions.

These objects, together with other objects of the invention, along with the various features of novelty which characterize the invention, are pointed out with particularity in the following detailed description. For a better understanding of the invention, its operating advantages, and specific objects attained by its uses, reference should be had to the accompanying drawings and descriptive material in which there is illustrated a preferred embodiment of the invention.

Further, the purpose of the abstract of this invention is to enable the US Patent and Trademark Office, the public generally, and especially scientists, engineers and practitioners in the art not familiar with patent or legal terms or phraseology to determine quickly from a cursory inspection the nature and essence of the technical disclosure of the application. The abstract is not intended to be limiting as to the scope of the invention in any way.

### BRIEF DESCRIPTION OF THE DRAWINGS

The invention will be better understood when consideration is given to the following detailed description of the invention. Such description makes reference to the following drawings:

FIG. 1 is a front view of a CNC milling machine and coolant delivery system as utilized in the present invention showing coolant nozzles directed at a tool tip.

FIG. 2 is a front view of the CNC milling machine and coolant delivery system shown in FIG. 1 enlarged to show more detail in the region of the coolant delivery system.

FIG. 3 is a front view of a CNC milling machine and coolant delivery system as utilized in the present invention showing coolant nozzles directed at the interface of the tool tip and a work piece.

FIG. 4 is a front view of the CNC milling machine and coolant delivery system as shown in FIG. 3 enlarged to show more detail in the region of the coolant delivery system.

FIG. 5 is a front view of a CNC lathe and coolant delivery system as utilized in the present invention.

FIG. 6 is a schematic of the computer control system.

### DETAILED DESCRIPTION AND BEST MODE OF IMPLEMENTATION

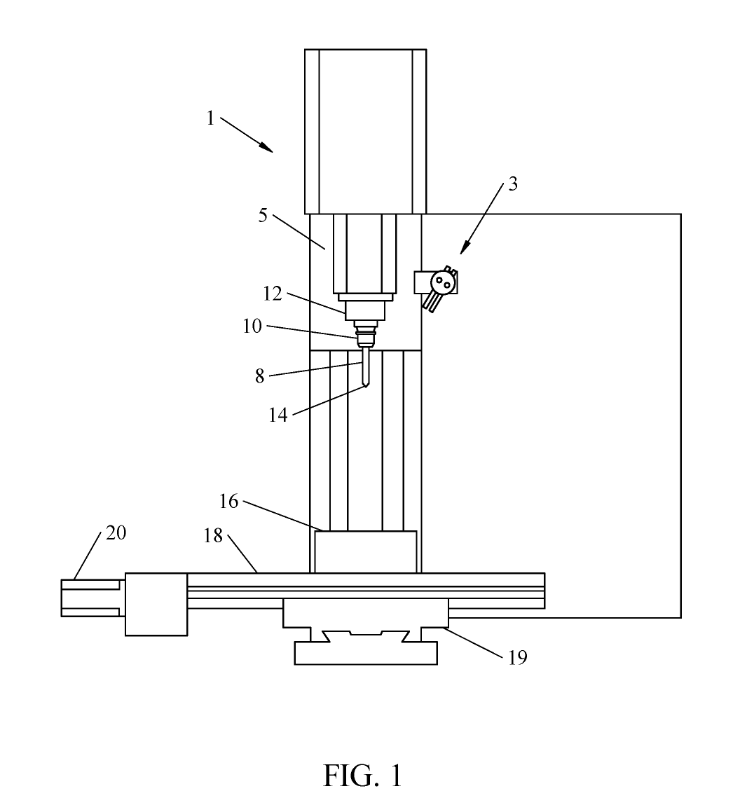

With reference now to the drawings, wherein like numerals designate like parts, FIG. 1 is a front view of a CNC milling machine 1 with coolant delivery system 3 mounted on spindle head 5. Cutting tool 8 is mounted in collet 10 and driven by spindle assembly 12. The tip 14 of cutting tool 8 is frequently the target for application of coolant. Work piece 16 is mounted on table 18 which is supported by saddle 19 and driven by driving means 20.

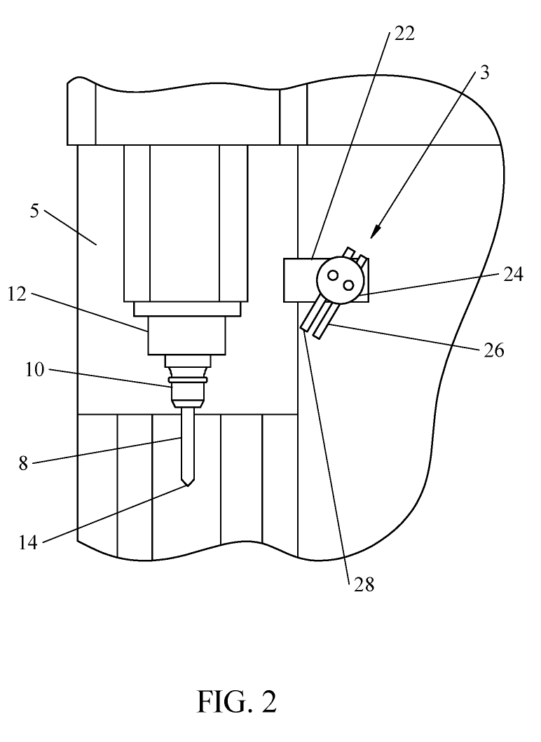

As shown in FIG. 2 coolant delivery system 3 includes a base or housing 22, which may contain the coolant delivery system computer and software (not shown), and a rotating nozzle block 24. Two coolant nozzles 26 and 28 are shown mounted to rotating nozzle block 24. Conventional driving means (not shown) are used to rotate rotating nozzle block 24 relative to base 22 under computer control. Conventional coolant storage tank, pump, solenoid and coolant hoses (not shown) are used to supply coolant to coolant nozzles 26 and 28. As best seen in FIG. 2 rotating nozzle block 24 has been positioned so that coolant nozzles 26 and 28 are targeting tool tip 14.

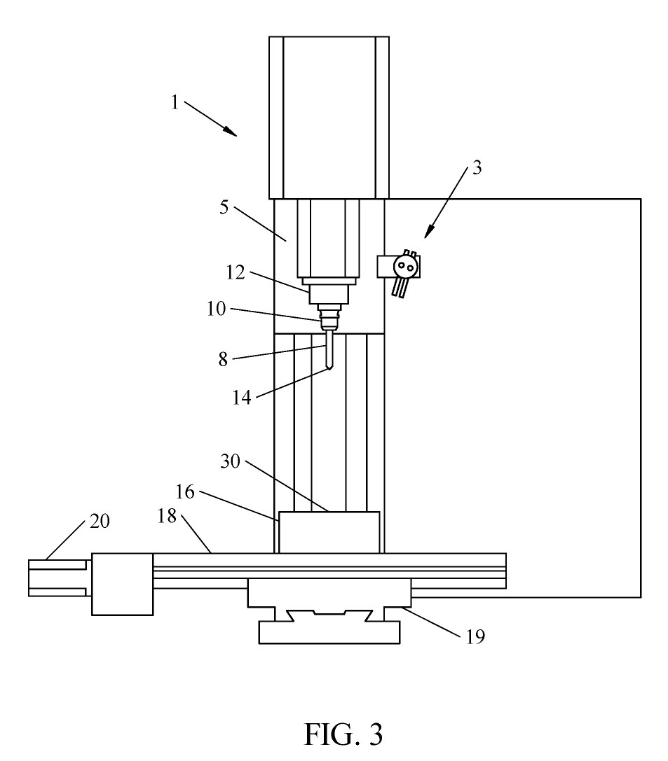

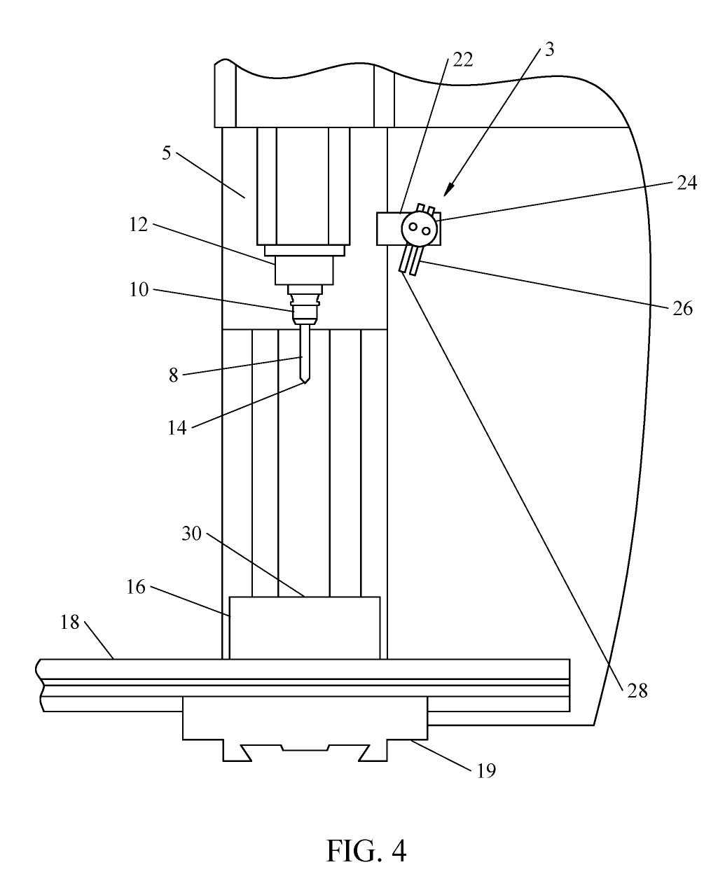

FIG. 3 shows another front view of a CNC milling machine 1 with coolant delivery system 3. FIG. 4 is an enlarged view of the mill shown in FIG. 3 showing more detail in the region of coolant delivery system 3. As best seen in FIG. 4 rotating nozzle block 24 has been rotated to direct coolant nozzles 26 and 28 towards the interface 30 of work piece 16 and tool tip 14.

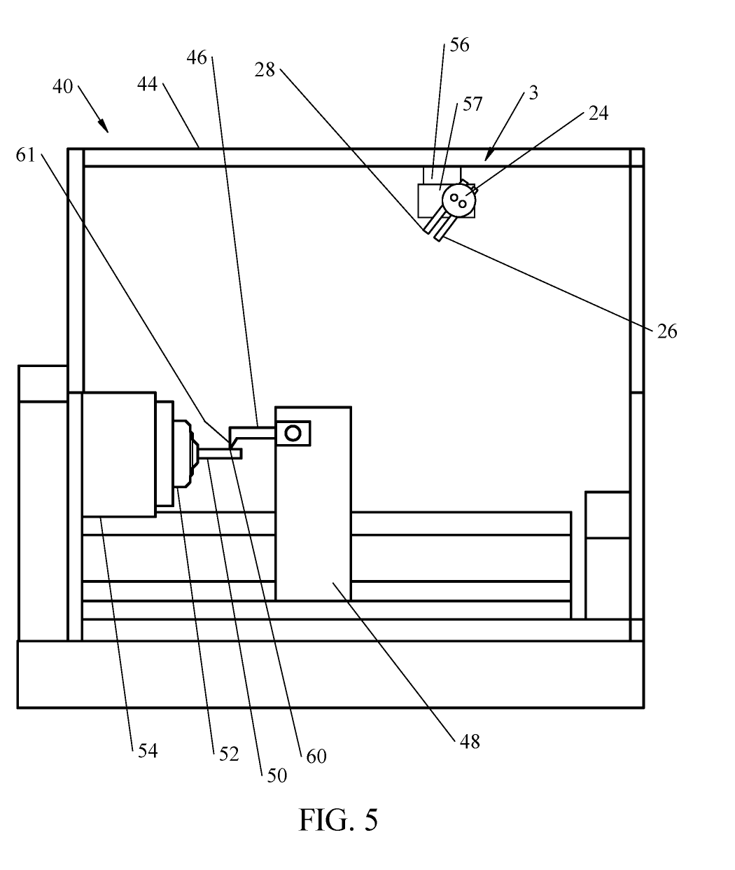

The embodiment shown in FIG. 5 is a front view of a CNC lathe 40 with coolant delivery system 3 mounted on lathe enclosure 44. Cutting tool 46 is mounted on cross slide 48. A work piece 50 is mounted in chuck 52 which is driven by driving means 54. Coolant delivery system 3 includes base 56, rotating block 57, and rotating nozzle block 24. Coolant nozzles 26 and 28 are mounted to rotating nozzle block 24. In the operating mode shown in FIG. 5 coolant nozzles 26 and 28 are targeting the interface 60 between work piece 50 and cutting tool tip 61. A conventional coolant storage tank, pump, solenoid and coolant hose (not shown) are used to supply coolant to coolant nozzles 26 and 28.

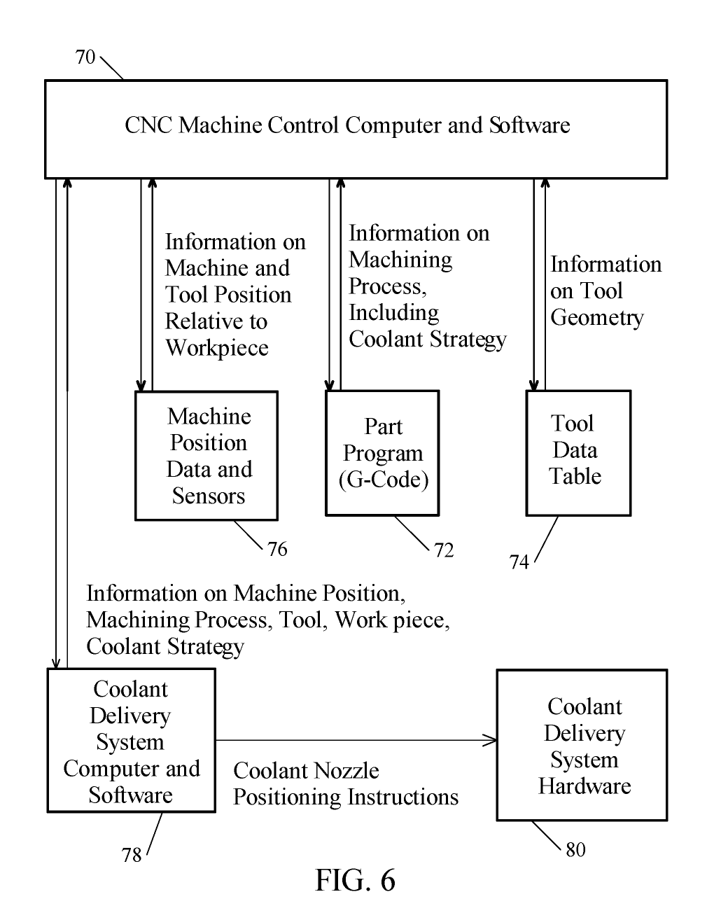

FIG. 6 shows a schematic of the fluid delivery control system. CNC machine control computer and software 70 controls the overall machining process. CNC machine control computer and software 70 interacts with G-Code part program 72 to determine which tool to use at a given time and how to guide that tool relative to a work piece. CNC machine control computer and software 70 reads tool geometry data from tool data table 74 and information on machine position relative to the work piece from machine position data 76.

When CNC machine control computer and software 70 receives instructions relevant to coolant delivery from G-Code part program 72 it provides that information to coolant delivery system computer and software 78. CNC machine control computer and software 70 also provides information to coolant delivery system computer and software 78 regarding tool position, work piece position and the machining process.

Coolant delivery system computer and software 78 then applies algorithms to this information and generates coolant nozzle positioning instructions which it provides to coolant delivery system hardware 80. A key feature of the present invention is that the user does not input any information on nozzle position associated with a specific cutting tool. This is a significant improvement over the prior art which requires a user to enter or program nozzle position information for each cutting tool. In addition, coolant delivery system computer and software 78 can respond in real-time to changes in G-Code part program 72 and thus change coolant delivery parameters in real time as a G-Code part program is executing.

Another key feature of the present invention is that the position of the nozzle(s) 26, 28 of the coolant delivery system 3 are not statically programmed by the user to a fixed location. Instead, the position of the coolant nozzle(s) is computed within the CNC machine control program according to a user selected strategy. The strategy is specified within the control language of the part control program, i.e. G-Code, and is used to determine the target location of the coolant nozzles 26,28.

The nozzle position is algorithmically derived from the user selected strategy, the tool geometry, and the position of the tool and machine relative to the cutting surface. The position and orientation of the nozzle is dynamic, and is continuously adjusted if any of the determining values changes. The coolant delivery system of the present invention provides one or two axes of motion to direct the coolant to points along a lathe or mill axes.

Using G-Code commands the present invention allows the user to select:

a) A coolant type (by selecting a coolant nozzle);

b) A coolant target relative to the tool tip, for example; at the tool tip, offset from the tool tip some distance, or at the location where a tool enters a surface of the component being machined, i.e. a surface of a work piece;

c) A coolant target relative to the work piece or object being cut, for example; at the location where the tool enters a surface of the component being machined (such as in a drilling or tapping operation), or at a surface of the component being machined (such as in a facing or turning operation);

d) Oscillation of the coolant stream between an above selected location and a predetermined offset (rotating the coolant delivery mechanism in a periodic manner); and

e) Pulsation of the coolant stream (turning the coolant pump or solenoid on and off in a periodic manner).

The coolant delivery system 3 comprises one or more nozzles 26,28 corresponding to the available coolant types. The rotating nozzle block 24 of the coolant delivery system 3, which is positioned by the above algorithm, may contain multiple coolant types each in a plurality of unique dispensers/nozzles mounted to rotating nozzle block 24, but at different spatial locations.

When machining a work piece, different types of coolant may be employed with different types of cutting operations to achieve a higher material removal rate, surface finish, or optimal life of a cutting tool edge. Under user program control, any of the available coolant types may be selected. The positioning algorithm further adjusts the position and/or orientation of the rotating nozzle block 24 via the mechanism of the coolant delivery system to optimize coolant delivery to a given target location regardless of coolant nozzle(s) in use.

As shown in FIG. 1 the coolant delivery system 3 employs a base 22 mounted in a strategic location on the machine frame that affords a linear path to the target location. In the embodiment directed to a milling machine, shown in FIG. 1, the coolant delivery system 3 is mounted on the machine component which holds the cutting tool spindle 12. The coolant delivery system 3 may be mounted anywhere in space that enables algorithmic determination of the target location, derived from machine control computer information and G-Code part program information which includes machine position, work location and cutting tool geometry.

FIG. 1 also depicts one of the coolant delivery strategies, which automatically directs the coolant stream at the cutting tool tip 14, or at an offset from the tool tip 14 based on the selected strategy by the user in the part program (G-Code). The algorithm directs the location of the rotating nozzle block 24 to a specific angular deflection, thereby varying the location the cutting fluid stream impacts the work piece and/or cutting tool tip 14. In this embodiment, a single rotary mechanism is used along a single axis of rotation. In other embodiments, multiple axis or rotation and translation may be employed in this technique to achieve aiming of the coolant stream. For example, in FIG. 5 two axis of rotation are employed to achieve aiming of the coolant stream.

FIG. 3 depicts an alternate strategy which points the coolant stream at a fixed location on the object being machined, typically referred to as “the part” or the “work piece.” In this strategy the aiming algorithm accounts for the position of the coolant delivery system in space relative to the cutting surface of the part, and dynamically adjusts rotating nozzle block 24 to direct the coolant stream to a fixed location on the part as coolant delivery system 3 changes location relative to that part. Since the algorithm has access to the information in the CNC control program, it is capable of dynamically repositioning rotating nozzle block 24 as needed to keep the coolant stream on target even as the physical position of coolant delivery system 3 moves in space, for example due to machine tool head 5 moving.

Both FIG. 1 and FIG. 3 depict multiple coolant delivery nozzles on the rotating nozzle block 24 of the mechanism. Each nozzle is assigned to a coolant type. When the part program selects one or more coolant types the algorithms of coolant delivery system 3 compute the optimal rotational angle and sequence to position the coolant nozzle(s), using the pre-assigned nozzle(s) as a basis for the geometric calculations.

While FIG. 5 depicts a CNC lathe 40 with the coolant delivery system 3 mounted on the lathe enclosure 44, coolant delivery system 3 may be mounted in any strategic location on the machine frame that affords a linear path to the interface between the cutting tool 46 and the work piece 50. The apparatus may be mounted anywhere in space that enables algorithmic determination of target location, derived from machine axes position, work location and geometry and cutting tool geometry. In alternative embodiments, the coolant delivery apparatus may be mounted on another surface of the lathe, including a surface which moves with one or more of the lathe axes, such as on cross slide 48.

FIG. 5 also depicts one of the coolant delivery strategies, which automatically directs the coolant stream at the cutting tool tip 61, or at an offset from the cutting tool tip 61, based on specifications in the part program (G-Code). The algorithm directs the position of the rotating block 57 and rotating nozzle block 24 to specific angular deflections, thereby varying the location of the nozzles 26 and 28 as required to position the coolant stream at the desired location.

In this embodiment, the coolant delivery apparatus has two axes of rotation, each driven by an independent rotary mechanism. Rotating nozzle block 24 is mounted to rotating block 57 which in turn is mounted to base 56.

The apparatus, algorithms and system of the present invention has three modes of automatic operation:

1. Tool Tip Mode: Select a coolant target relative to the tool tip, for example; at the tool tip, offset from the tool tip some distance, or at the location where a tool enters a surface of the component being machined, i.e. a surface of a work piece;

2. Work Surface Mode: Select a coolant target relative to the work piece or object being cut, for example; at the location where the tool enters a surface of the component being machined (such as in a drilling or tapping operation), or at a surface of the component being machined (such as in a facing or turning operation) This mode can aim the coolant stream at the Z axis (vertical axis) zero plane or a programmed distance from the Z zero plane; and

3. Oscillation Mode: Oscillation of the coolant stream position (rotating the coolant delivery mechanism in a periodic manner) about a given target location.

Each of the above modes may be modified by the following modifier modes:

A. Pulsation of the coolant stream (turning the coolant pump or solenoid on and off in a periodic manner); and

B. Selection of a coolant type.

By combining these three modes and two modifier modes there are a total of six modes of operation. Manual operation (jogging the coolant delivery mechanism via key press) is also possible.

Method of Mode 1, Tool Tip Mode

When an ‘M7 P0’ (mist) or ‘M8 P0’ (flood) coolant command is encountered in a CNC part program (G-Code program) with a P value present as shown (‘P0’), the coolant delivery system software uses the value of the currently applied tool length offset to calculate the angle of the coolant delivery rotating block(s). This departs from prior art coolant delivery systems in the following ways:

1. The coolant delivery system control software does not need to be trained. Prior art coolant delivery systems save the position of the coolant stream in a separate register from the tool length register. The apparatus and method of the present invention is able to directly access the currently applied tool length offset from the machine control computer, which means that the user does not have to set up coolant delivery information for any specific tool in the system.

2. The present invention accesses the currently applied tool length offset, not the tool length offset for the currently loaded tool. The G-Code specification for applying tool length offset via the G43 command takes an optional H value, which allows users to apply a different length offset for a given tool. Because the present invention uses the currently applied tool length offset value, the location of the coolant stream is not coupled to tool number, but instead uses the current tool length offset. This means that the coolant target will be determined based the current maching strategy the user has implemented for a given tool, not simply on the tool length.

As discussed above the present invention implementation for M7 (mist) and M8 (flood) allows an optional value (specified by a ‘P’ word) for applying an extra offset to the coolant position. The machine control software parses the M7/M8 line, and if a P value is found, it applies the current tool length offset plus or minus the P word offset.

This allows the operator to programmatically change the exact location of the coolant stream without retraining the coolant nozzle as is required in the prior art. Practically speaking, this means that the location of the coolant stream with respect to the tool tip is changeable via G-Code at any time, including while a part program is running, which is not something that the other prior art systems are capable of.

Method of Mode 2, Work Surface Mode

When an ‘M7’ (mist) or ‘M8’ (flood) coolant command is encountered in a CNC program (with no P value present) the control software uses the current machine Z axis position in work offset coordinates to calculate the position of the coolant delivery nozzle(s). For example, when the coolant delivery system 3 is mounted on the spindle head of a milling machine, which moves up and down along the Z axis, the coolant delivery apparatus must have knowledge of the current milling machine head 5 position to accurately direct the coolant at the work offset coordinate system zero point or some offset from this point. The software of the present invention retrieves the work offset coordinate system zero point in reference to the Z axis by using the following algorithm:

1 Retrieving the current machine position at a 1 khz interval

2. Subtracting the active G5x Z offset

3 Subtracting the active tool length offset

4. Subtracting the current G52/G92 offset

This allows the coolant delivery system 3 of the invention to maintain the coolant stream target at the work piece Z axis zero position, or an offset from this position, as the spindle head 5 and the coolant delivery system move in Z position.

Method of Mode 3, Oscillation Mode

When an ‘M7’ (mist) or ‘M8’ (flood) coolant command is encountered in a CNC program and an ‘R’ word is found on the G-Code line, the present invention will oscillate the coolant stream at a distance specified by the R value relative to the normal position. The normal position being specified by either Tool Tip Mode or Work Surface Mode, depending on the presence or lack of the P word on the G-Code line, as discussed above.

Method of Modifier Mode A, Pulse (Available in Method Modes 1-3):

When an ‘M7’ (mist) or ‘M8’ (flood) coolant command is encountered in a CNC program and a ‘Q’ word is found on the G-Code line, the present invention will pulse the coolant on and off at the time interval specified by the Q value.

Method of Modifier Mode B, Coolant Type (Available in Method Modes 1-3):

When an ‘M7’ (mist) coolant command is encountered in a CNC program the coolant connected to one nozzle is delivered. When an ‘M8’ (flood) coolant command is encountered in a CNC program the coolant connected to a second nozzle is delivered. The use of additional nozzles selected by additional M commands is possible but seldom necessary.

In summary the present invention enables: Directing the coolant stream at a location that is fixed in space even as the coolant delivery system 3 moves, for example up and down when mounted to the head of a milling machine; Allowing the user to change the location of the coolant stream during part program execution by changing G-Code commands; Direction of coolant nozzle position based on currently applied tool length offset in the CNC machine control program; Aiming of coolant based on the current CNC machine axes position; Aiming of coolant based on a P word offset; Aiming of coolant based on part program (G-Code) supplied strategies; Aiming of coolant at the intersection of the cutting tool and a location on the part; Multiple coolant nozzles mounted on a common rotational mechanism; Assignment of coolant type to a particular nozzle; and Adaptive aiming of coolant based on a selected nozzle, for example temporarily re-aiming and delivering air intermittently to clear chips using one nozzle when using flood coolant from another nozzle.

The advantages of the invention should now be readily apparent to those skilled in the art without the necessity for a more detailed description of the elements. With respect to the above description it is to be understood that the optimal dimensional relationships for the parts of the invention, to include variations in size, materials, shape, form, function and manner of operation, assembly, and use, are deemed readily apparent and obvious to one skilled in the art. All equivalent relationships to those illustrated in the drawings and described in the specification are intended to be encompassed by the present invention.

Therefore, the foregoing is to be considered as only illustrative of the principles of the invention. Since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A coolant delivery system for use on a computer numerically controlled (CNC) machine comprising:
a table or chuck for mounting a work piece to the CNC machine;
a tool for working the work piece;
a source of coolant;
a movable coolant nozzle operating under computer control configured to receive coolant from the source of coolant;
a coolant delivery system computer which does not require a user to enter, train, specify, program or in any way define any nozzle position information linked to a specific tool, which dynamically positions the coolant nozzle for the application of coolant by:
reading coolant mode instructions contained in a part program that defines the machining processes,
dynamically reading tool and work piece positions from a CNC machine control computer,
using algorithms to process the information on tool and work piece positions computes a desired coolant nozzle position, and
generating control signals for rotating, moving, or rotating and moving the coolant nozzle so as to maintain the application of coolant fluid at a desired coolant target location as one or more of the tool, the work piece or the coolant nozzle change position.

2. A coolant delivery system according to claim 1 where the information on tool position includes the currently applied tool length offset in the CNC machine control program.

3. A coolant delivery system according to claim 1 where the tool and work piece positions include the current CNC machine axes positions.

4. A coolant delivery system according to claim 1 where the coolant mode instructions contained in a part program that defines the machining processes can be changed while the part program is executing.

5. A coolant delivery system according to claim 1 where the coolant mode instructions contained in a part program that defines the machining processes can be manually overridden by a user while the part program is executing.

6. A coolant delivery system according to claim 2 where the coolant mode instructions contained in a part program that defines the machining processes can be changed while the part program is executing.

7. A coolant delivery system according to claim 6 which includes, when using coolant from one nozzle, the ability to temporarily re-aim and deliver coolant using a second nozzle.

8. In a coolant delivery system for use on a computer numerically controlled (CNC) machine with a table or chuck for mounting a work piece to the CNC machine, a tool for working the work piece, one or more sources of coolant, one or more movable coolant nozzles operating under computer control configured to receive coolant from the sources of coolant, and a coolant delivery system computer which does not require a user to enter, train, specify, program or in any way define any nozzle position information linked to a specific tool which dynamically positions the one or more coolant nozzles, a method for the application of coolant comprising the steps of:
reading coolant mode instructions contained in a part program that defines the machining processes, and
dynamically reading tool and work piece positions from a CNC machine control computer, and
using algorithms to process the information on tool and work piece positions computes the desired coolant nozzle position, and
generating control signals for rotating, moving, or rotating and moving the coolant nozzles so as to maintain the application of coolant fluid at the desired coolant target locations as one or more of the tool, the work piece or the coolant nozzle change position.

9. The method of claim 8 wherein the step of using algorithms to process the information on tool and work piece positions comprises using the currently applied tool length offset in the CNC machine control program.

10. The method of claim 8 wherein the step of dynamically reading tool and work piece positions from a CNC machine control computer comprises information on the current CNC machine axes positions.

11. The method of claim 8 wherein the step of reading coolant mode instructions contained in a part program that defines the machining processes comprises changing coolant mode instructions while the part program is executing.

12. The method of claim 8 wherein the step of reading coolant mode instructions contained in a part program that defines the machining processes comprises the ability to manually override coolant mode instructions by a user while the part program is executing.

13. The method of claim 9 wherein the step of reading coolant mode instructions contained in a part program that defines the machining processes comprises changing coolant mode instructions while the part program is executing

14. The method of claim 13 wherein the step of reading coolant mode instructions contained in a part program that defines the machining processes comprises, when using coolant from one nozzle, the ability to temporarily re-aim and deliver coolant using a second nozzle.

15. In a coolant delivery system for use on a computer numerically controlled (CNC) machine with a table or chuck for mounting a work piece to the CNC machine, a tool for working the work piece, one or more sources of coolant, one or more movable coolant nozzles operating under computer control configured to receive coolant from the sources of coolant, and a coolant delivery system computer which positions the one or more coolant nozzles, a method for the application of coolant comprising the steps of:
reading coolant mode instructions contained in a part program that defines the machining processes, and
dynamically reading tool and work piece positions from a CNC machine control computer, and
using algorithms to process the information on tool and work piece positions computes the desired coolant nozzle position, and
generating control signals for rotating, moving, or rotating and moving the coolant nozzles so as to maintain the application of coolant fluid at the desired coolant target locations as one or more of the tool, the work piece or the coolant nozzle change position.

16. The method of claim 15 wherein the step of using algorithms to process the information on tool and work piece positions comprises using the currently applied tool length offset in the CNC machine control program.

17. The method of claim 15 wherein the step of dynamically reading tool and work piece positions from a CNC machine control computer comprises information on the current CNC machine axes positions.

18. The method of claim 15 wherein the step of reading coolant mode instructions contained in a part program that defines the machining processes comprises changing coolant mode instructions while the part program is executing.

19. The method of claim 15 wherein the step of reading coolant mode instructions contained in a part program that defines the machining processes comprises the ability to manually override coolant mode instructions by a user while the part program is executing.

20. The method of claim 16 wherein the step of reading coolant mode instructions contained in a part program that defines the machining processes comprises changing coolant mode instructions while the part program is executing

21. The method of claim 20 wherein the step of reading coolant mode instructions contained in a part program that defines the machining processes comprises, when using coolant from one nozzle, the ability to temporarily re-aim and deliver coolant using a second nozzle.
